(19) United States
(12) Patent Application Publication
(10) Pub. No.: US 2025/0298919 A1
(43) Pub. Date: Sep. 25, 2025

(54) IMAGE PROCESSING APPARATUS AND ENCRYPTION SETTING METHOD IN IMAGE PROCESSING APPARATUS

(71) Applicant: SHARP KABUSHIKI KAISHA, Sakai City (JP)

(72) Inventor: TAKUYA KOUJIRO, Sakai City (JP)

(21) Appl. No.: 19/081,157

(22) Filed: Mar. 17, 2025

(30) Foreign Application Priority Data
Mar. 19, 2024 (JP) 2024-042951

(51) Int. Cl. G06F 21/62; G06F 21/60

(52) U.S. Cl. CPC G06F 21/6245; G06F 21/602

(57) ABSTRACT

An image processing apparatus includes: an encryptor that encrypts data; one or more controllers that control receiving of encryption setting for the data; and a display, wherein the one or more controllers display, on the display, one of a setting screen that receives the encryption setting or a confirmation screen with a content notifying that the data is already encrypted, in accordance with an encryption status of the data by the encryptor.

### CROSS-REFERENCE TO RELATED APPLICATION

The present application claims priority from Japanese Application JP2024-042951, the content to which is hereby incorporated by reference into this application.

### BACKGROUND OF THE INVENTION

### 1. Field of the Invention

The present disclosure relates to an image processing apparatus, and also to an encryption setting method in the image processing apparatus.

### 2. Description of the Related Art

As one of security measures in an image processing apparatus such as a multifunctional apparatus, there is known a technology of encrypting data to be stored so as to protect the data against damage such as unauthorized access or theft.

In association with such an encryption technology, there is known, for example, information processing equipment as a conventional art, which has a configuration relating to an encryption setting for data to be encrypted (also referred to as encryption target data), and displays a button for receiving encryption instructions for encryption target data if an encryption setting screen is closed while encryption of the encryption target data is canceled.

### SUMMARY OF THE INVENTION

An object of the present disclosure is to provide an image processing apparatus and also an encryption setting method in the image processing apparatus, which are able to improve user operability, with respect to an encryption setting for encryption target data.

As a solution to the above, an image processing apparatus according to one aspect of the present disclosure includes: an encryptor that encrypts data; one or more controllers that control receiving of encryption setting for the data; and a display, wherein the one or more controllers display, on the display, one of a setting screen that receives the encryption setting or a confirmation screen with a content notifying that the data is already encrypted, in accordance with an encryption status of the data by the encryptor.

An image processing apparatus according to another aspect of the present disclosure includes: an encryptor that encrypts data based on setting information set in advance; one or more controllers that control receiving of encryption setting for the data; and a display, wherein the one or more controllers control one of displaying, on the display, of a setting screen that receives the encryption setting or omitting of the displaying of the setting screen on the display, in accordance with an initialization status of the setting information of the image processing apparatus.

An encryption setting method according to further aspect of the present disclosure is an encryption setting method in an image processing apparatus including an encryptor that encrypts data; one or more controllers that control receiving of encryption setting for the data; and a display, the method including: displaying, on the display, one of a setting screen that receives the encryption setting or a confirmation screen with a content notifying that the data is already encrypted, in accordance with an encryption status of the data by the encryptor.

In accordance with the present disclosure, it is possible to provide an image processing apparatus and also an encryption setting method in the image processing apparatus, which are able to improve user operability, with respect to an encryption setting for encryption target data.

### BRIEF DESCRIPTION OF THE DRAWINGS

FIG. 1 is an illustration depicting an overall structure of an image processing apparatus according to a first embodiment.

FIG. 2 is a diagram explaining a configuration of the image processing apparatus according to the first embodiment.

FIG. 3 is a flowchart explaining a processing flow according to the first embodiment.

FIG. 4 is an illustration explaining an operation example according to the first embodiment.

FIG. 5 is an illustration explaining an operation example according to the first embodiment.

FIG. 6 is an illustration explaining an operation example according to the first embodiment.

FIG. 7 is an illustration explaining an operation example according to the first embodiment.

FIG. 8 is an illustration explaining an operation example according to the first embodiment.

FIG. 9 is a flowchart explaining a processing flow according to a second embodiment.

FIG. 10 is a flowchart explaining a processing flow according to a third embodiment.

FIG. 11 is an illustration explaining an operation example according to the third embodiment.

FIG. 12 is a flowchart explaining a processing flow according to a fourth embodiment.

### DETAILED DESCRIPTION OF THE INVENTION

Hereinafter, embodiments of the present disclosure will be described with reference to the drawings. Note that the following embodiments are examples for describing the present disclosure, and the technical contents described in the appended claims are not limited to the following description.

Conventionally, an encryption setting to encrypt data stored in a storage device, etc., installed in an image processing apparatus such as a multifunctional apparatus, has been arbitrarily set by a user such as an administrator.

On the other hand, in order to conform to various laws and regulations (e.g., Product Security and Telecommunication Infrastructure Bill (PSTI)) for enhancing security to Internet of Things (IoT) devices, or to acquire certification of Common Criteria (CC) in collaborative Protection Profile for Hardcopy Devices (HCDcPP), a multifunctional apparatus to be introduced into market in the subject regions, countries, etc., is required to comply with security requirements provided in the various laws and regulations or profiles.

For example, the section regarding Storage Encryption (conditionally mandatory) in HCDcPP (version1.0) provides that “If the Target of Evaluation (TOE) stores User Document Data or Confidential TOE Security Functionality (TSF) Data on Field-Replaceable Nonvolatile Storage Devices, it will encrypt such data on those devices.”

In order to satisfy the security requirements provided in HCDcPP, etc., some multifunctional apparatuses may be subjected to execution of encryption to data, at the time of factory shipment or initialization. However, a user possesses no measure to confirm whether or not the data has already been encrypted, and cannot skip a setting screen relating to unnecessary encryption setting even if the data has already been encrypted. In the above configuration, the user is required to perform again an operation to first confirm the setting, and it is difficult to say that an operability related to the encryption setting is excellent.

In the present disclosure, the following embodiments realizes the image processing apparatus and also the encryption setting method in the image processing apparatus, which are able to improve user operability, with respect to the encryption setting for the encryption target data.

### 1. First Embodiment

In the first embodiment, the configuration of a multifunctional apparatus 10 will be described, as an example of an image processing apparatus. The multifunctional apparatus 10 is an image processing apparatus capable of executing various jobs such as copying, faxing, e-mailing, etc., in a single housing. Note that the image processing apparatus is not limited to the multifunctional apparatus 10, and may be a printer, a copier, a facsimile machine, etc., having limited job functions.

### 1.1. Functional Configuration

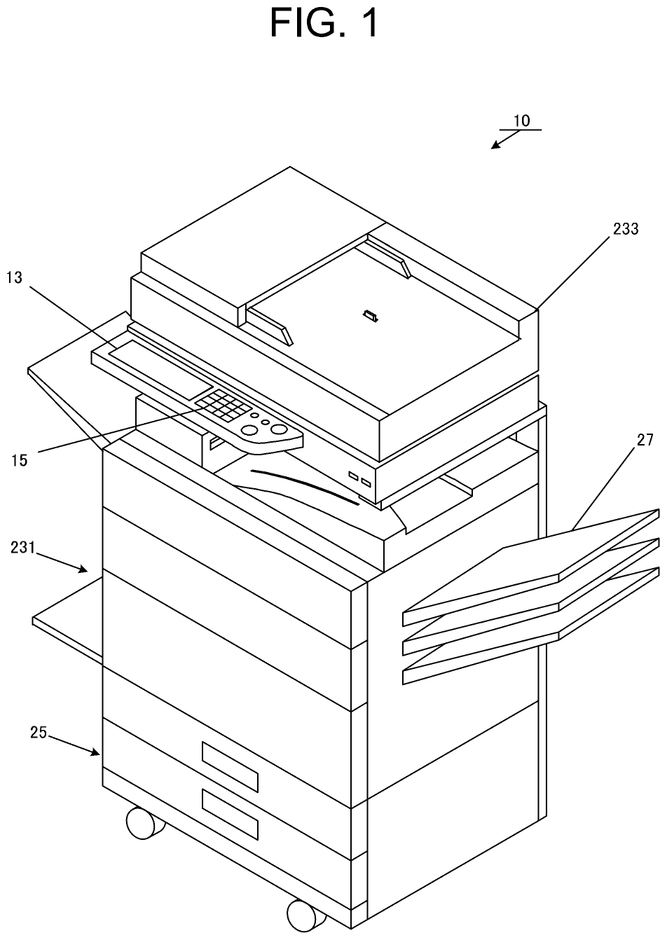

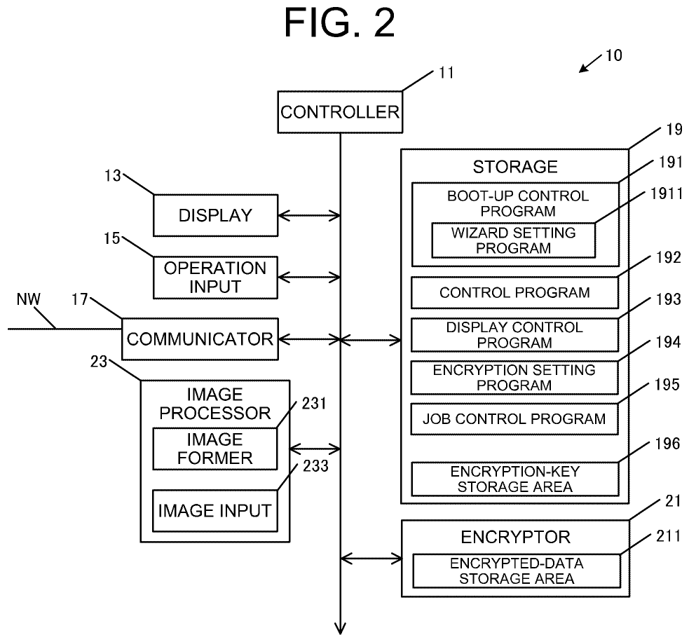

FIG. 1 is an illustration depicting an overall structure of the multifunctional apparatus 10 according to the first embodiment. FIG. 2 is a functional block diagram of the multifunctional apparatus 10.

The multifunctional apparatus 10 includes, as functional components, at least one controller 11, a display 13, an operation input 15, a communicator 17, a storage 19, an encryptor 21, and an image processor 23.

The controller 11 controls the multifunctional apparatus 10 in its entirety. The controller 11 may be configured by one or more processing devices (e.g., a central processing unit (CPU), a system on chip (SoC), etc.) The controller 11 achieves the functions thereof by reading and executing various programs stored in the storage 19.

The display 13 is a display device that displays various information to a user, etc. The display 13 may be configured by, for example, a liquid crystal display (LCD), an organic electro-luminescence (EL) display, and so forth. The display 13 displays, for example, a home screen (not depicted); an operation screen such as a job execution screen related to execution of each job; a login screen receiving an input of credentials (e.g., a login user name, a login password, etc.) of a user who attempts to log in the multifunctional apparatus 10; an initial setting-wizard screen executed first at power-on of the multifunctional apparatus 10 or after boot-up of the apparatus; a setting wizard screen executed, e.g., after initialization of the storage; and so forth, based on control performed by the controller 11 that reads a display control program 193 described later.

The operation input 15 is an input device that receives an input of information by a user, etc. The operation input 15 may be configured by, for example, various input devices such as operation keys such as hardware or software keys, buttons, and so forth. The operation input 15 may also be configured as a touch panel able to achieve an input via the display 13. In the case of being configured as a touch panel, the operation input 15 can detect user's touch, tap, swipe operations, etc., on an object displayed via the display 13, and can acquire coordinate information, pressure-sensitive information, etc., on the touch panel. In this case, an input type of the touch panel may adopt, for example, a general input type such as a resistive film type, an infrared type, an electromagnetic induction type, or a capacitance type.

The communicator 17 includes, for example, a wired interface and/or a wireless interface, that is used for communicating with another terminal device, etc., (not depicted) via a network NW such as a local area network (LAN), a wide area network (WAN), the Internet, a telephone line, a FAX line, and so forth. The communicator 17 may also include an interface related to wireless communication technology such as Bluetooth (registered trademark), Near Field Communication (NFC), Wi-Fi (registered trademark), Infrared Data Association (IrDA), wireless Universal Serial Bus (USB), and so forth.

The storage 19 is one or more storage devices that store various programs or various data, necessary for operating the multifunctional apparatus 10. The storage 19 may be configured by a storage device such as a random access memory (RAM), a solid state drive (SSD), a hard disk drive (HDD), a read only memory (ROM), and so forth.

In the first embodiment, the storage 19 stores a boot-up control program 191, a control program 192, a display control program 193, an encryption setting program 194, and a job control program 195, and ensures an encryption-key storage area 196.

The boot-up control program 191 is a program read by the controller 11 at boot-up of the multifunctional apparatus 10. The controller 11 that has read the boot-up control program 191 controls boot-up processing of the multifunctional apparatus 10. The boot-up control program 191 may be included in, for example, boot firmware or main firmware activated through verification by the boot firmware. In order to realize secure boot, the boot-up control program 191 may be stored in another storage device (storage area) (not depicted) different from the storage 19, or in another terminal device, etc., (not depicted) on the network NW.

The boot-up control program 191 includes a wizard setting program 1911. The controller 11 reads the wizard setting program 1911 at the time of boot-up of the multifunctional apparatus 10, for example, at the first boot-up after power-on, or at boot-up after the storage 19 is initialized, which requires the initial setting of the multifunctional apparatus 10. The controller 11 that has read the wizard setting program 1911 proceeds with the (initial) setting process while displaying, on the display 13 (or the operation input 15), a wizard screen that receives assistance for initial setting or an input of apparatus setting.

The control program 192 is a program read by the controller 11 after the apparatus is booted up based on the boot-up control program 191. The controller 11 that has read the control program 192 functions as an operating system (OS) and controls driving of hardware such as the display 13, the operation input 15, the communicator 17, the encryptor 21, the image processor 23, and so forth.

The display control program 193 is a program read by the controller 11 to perform output control of a screen, displayed on the display 13 or the operation input 15 configured as a touch panel. The controller 11 that has read the display control program 193 controls screen display on the display 13 (or the operation input 15).

The encryption setting program 194 is a program read by the controller 11 when receiving an encryption setting by a user. The controller 11 that has read the encryption setting program 194 determines whether to display one of a setting screen that receives the encryption setting or a confirmation screen with a content notifying that the data has already been encrypted, in accordance with an encryption status of the data by the encryptor 21. In this connection, the “encryption” according to the present disclosure refers to general technologies that restrict access of a user other than an authenticated user by encrypting encryption target data based on a predetermined algorithm. It is also possible to restrict the access to the encryption target data by directly encrypting the encryption target data or hiding the storage position of the encryption target data. Further, the “encryption target data” according to the present disclosure may be in units of files, in units of folders, in units of storage areas with a specific size, or in unit of main body of the storage 19.

The encryption setting program 194 may be configured, as depicted in FIG. 2, as a native application that functions when being read by the controller 11, or the wizard setting program 1911 may have the function of the encryption setting program 194. In this case, the function fulfilled by the encryption setting program 194 may be provided as one function of an initial setting wizard.

The job control program 195 is a program read by the controller 11 when executing a print job related to printing, copying, etc., or a job related to facsimile or image transmission. The controller 11 that has read the job control program 195 shifts to a job mode (e.g., a print mode, a copy mode, a facsimile mode, an image transmission mode, etc.) for executing each job, and executes the job. When executing the job, the controller 11 can display, as needed, an operation screen that receives a user selection of set value or function, necessary to execute the job, on the operation input 15 configured as a touch panel. The controller 11 can execute the job based on the set value or function received via the operation input 15.

The encryption-key storage area 196 is a storage area that stores an encryption key used for executing decryption of data encrypted by the encryptor 21 (also referred to as encrypted data) or an access to the encrypted data. An access to the encryption-key storage area 196 (or the encryption key stored therein) is restricted in accordance with a protection mode of the encryptor 21. The encryption-key storage area 196 may be stored in another storage device (storage area) (not depicted) different from the storage 19, or in another terminal device, etc., (not depicted) on the network NW.

The encryptor 21 may be configured as a self-encryption drive that mounts a dedicated chip for achieving encryption and decryption of the encryption target data. The encryptor 21 configured as a self-encryption drive encrypts encryption target data to be stored, based on a predetermined algorithm. In this connection, the encryptor 21 can operate in different two operation modes (unprotected mode and protected mode). When the operation mode is the unprotected mode, the encryptor 21 does not restrict an access to the encryption-key storage area 196 (or the encryption key stored therein). In the unprotected mode, it is possible to perform decryption of or access to the encrypted data by using the encryption key without restriction. On the other hand, when the operation mode is the protection mode, the encryptor 21 restricts (protects) the access to the encryption-key storage area 196 (or the encryption key stored therein). In the protected mode, decryption of or access to the encrypted data by using the encryption key is permitted only to the authenticated user. Since the encrypted state of data is maintained against a user other than the authenticated valid user, it is possible to prevent unauthorized access to or abuse of the encrypted data by the other user. The encryptor 21 may be configured as a native application stored in the storage 19. In this case, the encryption-key storage area 196 is preferably stored in another storage device (storage area) (not depicted) different from the storage 19, another terminal device (not depicted) on the network NW, and so forth.

Incidentally, in the present disclosure, a situation in which the operation mode of the encryptor 21 is the unprotected mode is defined as “data is not encrypted” as the encryption status of data, and a situation in which the operation mode of the encryptor 21 is the protected mode is defined as “data is already encrypted” as the encryption status of data. The controller 11 that has read the encryption setting program 194 can determine the encryption status of the encryption target data based on the operation mode of the encryptor 21.

An encrypted-data storage area 211 is a storage area that stores the encryption target data (encrypted data) encrypted by the encryptor 21.

The image processor 23 includes an image former 231 and an image input 233. The image former 231 feeds a sheet from a sheet feeder 25, forms an image on the sheet based on image data, and thereafter discharges the sheet to a sheet catcher 27. The image former 231 may be configured by, for example, a laser printer, etc., employing an electrophotographic system. In this case, the image former 231 performs image formation by using toners supplied from toner cartridges (not depicted) corresponding to toner colors (e.g., cyan, magenta, yellow, and black).

The image input 233 generates image data by scanning a document. The image input 233 may be configured as, for example, a scanner device that is provided with an image sensor such as a charge coupled device (CCD) or a contact image sensor (CIS) and further includes an automatic document feeder (ADF), a flatbed for placing and reading a document, and so forth. The configuration of the image input 233 is not particularly limited as long as a light image reflected from a document image can be read by the image sensor. The image input 233 may also be configured as an interface that is able to acquire image data stored in a storage medium such as a USB memory or image data transmitted from a terminal device (not depicted). The image processor 23 may have a configuration to perform, for example, shading correction or density correction, on the image data input from the image input 233, so as to generate image data for image transmission.

### 1.2. Processing Flow

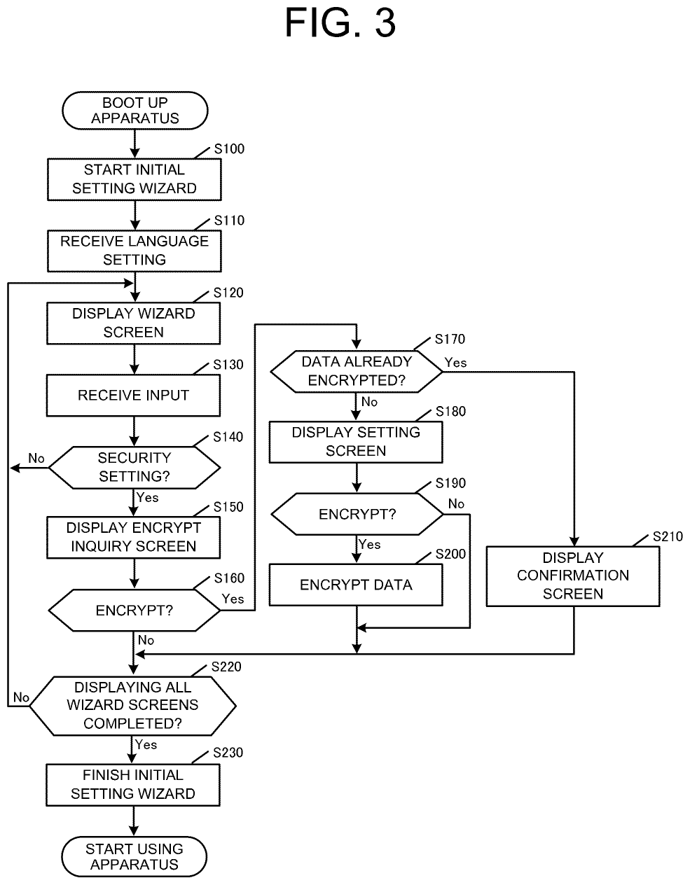

A processing flow according to the first embodiment will now be described with reference to a flowchart depicted in FIG. 3. The process described along the flowchart of FIG. 3 is a process executed by the controller 11 that has read the boot-up control program 191 (wizard setting program 1911), the control program 192, the display control program 193, the encryption setting program 194, and so forth. In FIG. 3, an exemplary form in which a process related to the encryption setting is included in setting items (security-related settings) in an initial setting wizard will be described.

After boot-up of the multifunctional apparatus 10, the controller 11 starts the initial setting wizard by reading the boot-up control program 191 (wizard setting program 1911) (step S100). Upon starting the initial setting wizard, the controller 11 receives a setting of language from a user through a “language setting” wizard screen (step S110).

Next, the controller 11 displays a wizard screen corresponding to the language received at step S110 (a language understandable by the user) (step S120). Then, the controller 11 receives an input of necessary set values, etc., via the wizard screen (step S130).

The controller 11 determines whether or not a content of setting received via the wizard screen is a security setting (step S140). If determining that the content of setting received via the wizard screen is the security setting (“Yes” at step S140), the controller 11 displays an inquiry screen that inquires whether to encrypt data (encryption target data) in the multifunctional apparatus 10 (step S150). If determining that the content of setting received via the wizard screen is not the security setting (“No” at step S140), the controller 11 repeats displaying the wizard screen (step S120) and receiving the input of set values, etc. (step S130), until the content of setting received via the wizard screen becomes a security-related setting.

Upon receiving instructions to execute encryption via the inquiry screen (“Yes” at step S160), the controller 11 determines whether or not the encryption target data is already encrypted by the encryptor 21 (step S170). If determining that the encryption target data is already encrypted by the encryptor 21 (“Yes” at step S170), the controller 11 decides to display a confirmation screen with a content notifying that the encryption target data is already encrypted, and thus displays the confirmation screen (step S210). Then, the controller 11 proceeds with the process from step S210 to step S220.

On the other hand, if determining that the encryption target data is not yet encrypted by the encryptor 21 (“No” at step S170), the controller 11 decides to display a setting screen that receives the encryption setting, and thus displays the setting screen (step S180).

Next, the controller 11 determines whether or not instructions to execute encryption has been received via the setting screen (step S190). If determining that the instructions to execute encryption has been received via the setting screen (“Yes” at step S190), the controller 11 outputs instructions to encrypt the encryption target data to the encryptor 21. Upon receiving the instructions to encrypt the encryption target data, the encryptor 21 switches the operation mode from the unprotected mode to the protected mode, and thereby encrypts the encryption target data (step S200). Then, the controller 11 proceeds with the process from step S200 to step S220. If determining that the instructions to execute encryption has not been received via the setting screen (“No” at step S190), the controller 11 proceeds with the process to step S220.

If determining that the instructions to execute encryption has not been received via the inquiry screen (“No” at step S160), the controller 11 determines whether or not displaying all wizard screens has been completed (step S220). If determining that displaying all wizard screens has been completed (“Yes” at step S220), the controller 11 finishes the initial setting wizard and starts using the apparatus (step S230). If determining that displaying all wizard screens has not been completed (“No” at step S220), the controller 11 returns the process to step S120.

### 1.3. Operation Example

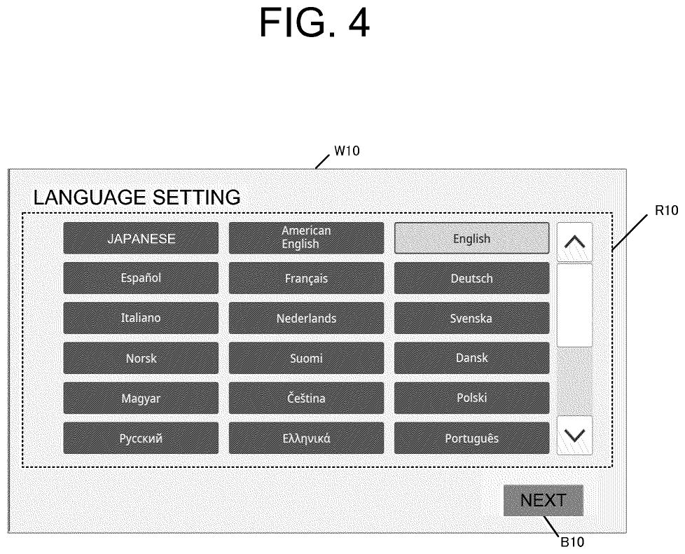

An operation example according to the first embodiment will be described below. FIG. 4 is an illustration explaining an example of configuration of a wizard screen W10 concerning the “language setting”. The “language setting” wizard screen W10 is a wizard screen displayed by the controller 11 at step S110 of FIG. 3. The wizard screen W10 includes a language selection area R10 and a next button B10. The language selection area R10 is a selection area that receives a language selection by the user. When a desired language is selected by the user, the selected language is displayed in a recognizable manner (e.g., reversed), and the user can grasp the selected language. The next button B10 is a selection button that receives determination instructions from the user regarding the language selection. Upon receiving the determination instructions from the user by the selection of next button B10, the controller 11 displays a wizard screen expressed in the user selected language.

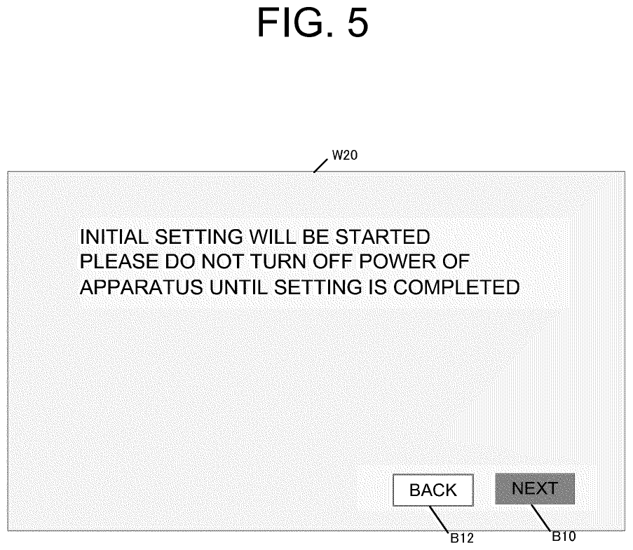

FIG. 5 is an illustration explaining an example of configuration of a “start confirmation” wizard screen W20 in the initial setting wizard. The “start confirmation” wizard screen W20 is an example of a wizard screen displayed by the controller 11 after displaying the “language setting” wizard screen W10. The “start confirmation” wizard screen W20 includes a notification of starting the initial setting wizard through the wizard screen (e.g., “Initial setting will be started. Please do not turn off power of apparatus until setting is completed.”), a next button B10, and a back button B12. The user who has confirmed that the initial setting wizard will be started selects one selection button of either the next button B10 or the back button B12.

The next button B10 is a selection button that receives confirmation instructions from the user regarding the start of the initial setting wizard. Upon receiving the confirmation instructions from the user by the selection of next button B10, the controller 11 shifts the screen to a wizard screen related to the next initial setting wizard. The back button B12 is a selection button that receives instructions to cancel the initial setting wizard. When receiving the instructions from the user by the selection of back button B12, the controller 11 shifts the screen to the former “language setting” wizard screen W10.

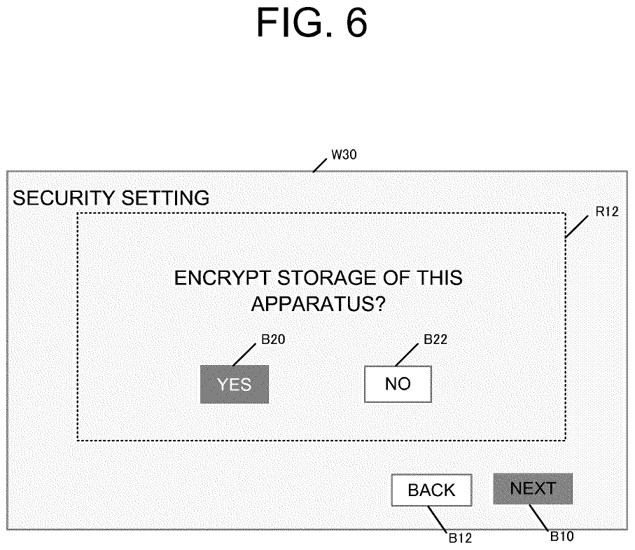

FIG. 6 is an illustration explaining an example of configuration of a “security setting” wizard screen W30 that is displayed by the controller 11 in a case where the content of setting received via the wizard screen is a security setting regarding the security of the multifunctional apparatus 10. The “security setting” wizard screen W30 is one form of the encryption inquiry screen displayed by the controller 11 at step S150 of FIG. 3.

The “security setting” wizard screen W30 includes an inquiry area R12 for inquiring of the user whether to encrypt the encryption target data, a next button B10, and a back button B12. The inquiry area R12 includes a notification of inquiring whether to encrypt the encryption target data (e.g., “Encrypt storage of this apparatus?”), a yes button B20, and a no button B22. The user who has confirmed the content of the notification selects one selection button of either the yes button B20 or the no button B22.

The yes button B20 is a selection button that receives a provisional selection of execution instructions to encrypt the encryption target data. Upon receiving the execution instructions by the selection of yes button B20, the controller 11 shows, for example, the yes button B20 to be darkened in a recognizable manner in order to indicate that the yes button B20 is in selected. The no button B22 is a selection button that receives a provisional selection of instructions to cancel encryption of the encryption target data. Upon receiving the instructions by the selection of no button B22, the controller 11 shows, for example, the no button B22 to be darkened in a recognizable manner in order to indicate that the no button B22 is in selected.

The next button B10 is a selection button that receives determination instructions of the provisional selection to the yes button B20 or the no button B22 in the inquiry area R12. Upon receiving the determination instructions by the selection of next button B10 in a state where the yes button B20 is provisionally selected, the controller 11 receives the execution instructions to encrypt the encryption target data. Upon receiving the execution instructions to encrypt the encryption target data, the controller 11 determines whether or not the encryption target data has already been encrypted by the encryptor 21. On the other hand, when receiving the determination instructions by the selection of next button B10 in a state where the no button B22 is provisionally selected, the controller 11 receives the instructions to cancel encryption of the encryption target data. Upon receiving the instructions to cancel the encryption of the encryption target data, the controller 11 finishes the inquiry process regarding whether to encrypt the encryption target data.

The back button B12 is a selection button that receives instructions to cancel the security setting via the “security setting” wizard screen W30. When receiving the instructions from the user by the selection of back button B12, the controller 11 shifts the screen to the former “start confirmation” wizard screen W20.

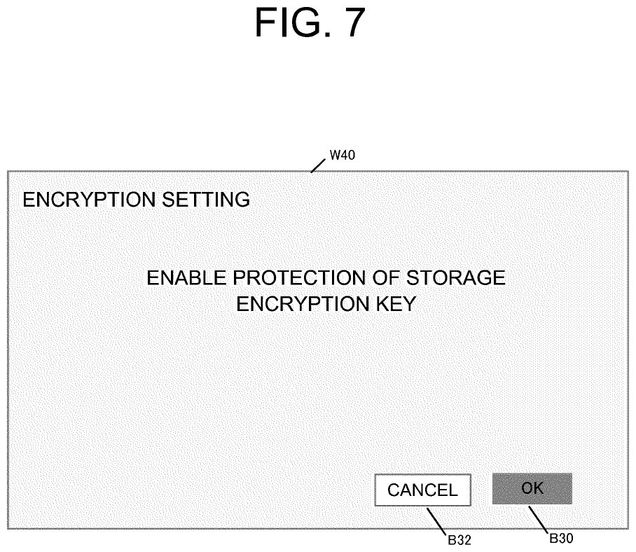

FIG. 7 is an illustration explaining an example of configuration of a setting screen W40 displayed by the controller 11 in a case where it is determined that the encryption of the encryption target has not yet been executed by the encryptor 21. FIG. 7 depicts an operation example corresponding to the processes from “No” at step S170 to step S180 in FIG. 3.

The setting screen W40 is a setting screen that receives execution instructions to encrypt the encryption target data by the encryptor 21. The setting screen W40 includes a notification of executing the encryption of the encryption target data by the encryptor 21 (e.g., “Enable protection of storage encryption key”), an OK button B30, and a cancel button B32. The user who has confirmed that the encryption of the encryption target data will be executed by the encryptor 21 selects one selection button of either the OK button B30 or the cancel button B32.

The OK button B30 is a selection button that receives the execution instructions to encrypt the encryption target data by the encryptor 21. Upon receiving the execution instructions from the user by the selection of OK button B30, the controller 11 outputs instructions to encrypt the encryption target data to the encryptor 21. The cancel button B32 is a selection button that receives instructions to cancel encryption of the encryption target data by the encryptor 21. When receiving the instructions from the user by the selection of cancel button B32, the controller 11 finishes the process regarding the encryption setting.

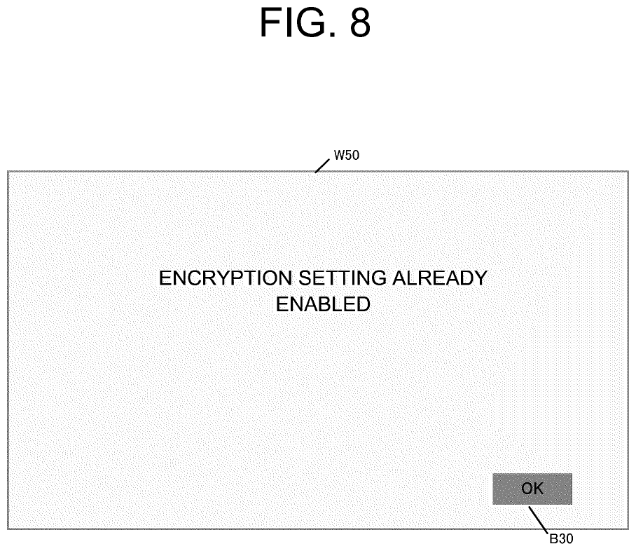

FIG. 8 is an illustration explaining an example of configuration of a confirmation screen W50 displayed by the controller 11 in a case where it is determined that the encryption of the encryption target has already been executed by the encryptor 21. FIG. 8 depicts an operation example corresponding to the processes from “Yes” at step S170 to step S210 in FIG. 3.

The confirmation screen W50 is a confirmation screen that notifies that the encryption target data has already been encrypted by the encryptor 21, and enables for the user to confirm the content of the notification. The confirmation screen W50 includes a notification that the encryption target data has already been encrypted by the encryptor 21 (e.g., “Encryption setting is already enabled”) and an OK button B30. The user who has confirmed that the encryption target data has already been encrypted by the encryptor 21 selects the OK button B30. Upon receiving instructions by the selection of OK button B30, the controller 11 finishes the process regarding the encryption setting.

As described above, the image processing apparatus according to the first embodiment determines, in accordance with the encryption status of data (encryption target data), whether to display one of the setting screen that receives the encryption setting or the confirmation screen with a content notifying that the data has already been encrypted. For example, in the case where the data has already been encrypted by the encryptor, the image processing apparatus omits displaying the setting screen for receiving the encryption setting, and notifies that the data has already been encrypted. The image processing apparatus according to the first embodiment makes it possible to reduce time and effort with respect to the encryption setting in the case where the data is already encrypted, and thus to improve user operability.

### 2. Second Embodiment

The second embodiment has a configuration in which it is determined, based on a factory default setting of an image processing apparatus, whether to display one of a setting screen that receives an encryption setting for encryption target data or a confirmation screen with a content notifying that encryption target data has already been encrypted. Described in the second embodiment is a case where a destination to which the image processing apparatus is shipped is, for example, an area (e.g., Europe) that indispensably requires the encryption target data to be encrypted at the time of shipment (or delivery) due to laws and regulations, etc.

The functional configuration of a multifunctional apparatus as the image processing apparatus according to the second embodiment may be analogous to the functional configuration of the multifunctional apparatus 10 according to the first embodiment, and thus the description thereof will be omitted.

### 2.1. Processing Flow

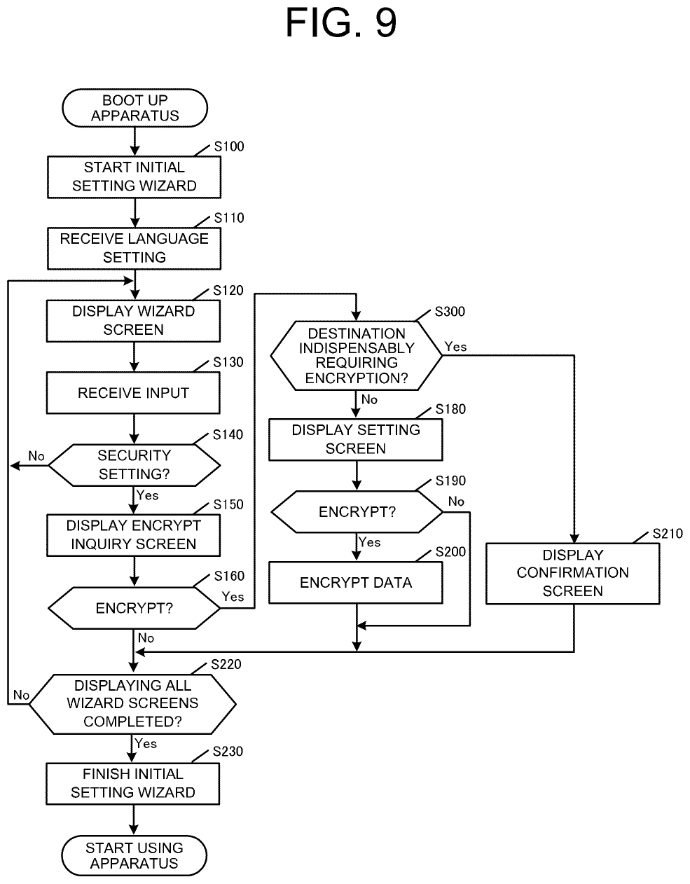

A processing flow according to the second embodiment is configured by replacing the flowchart (step S170) depicted in FIG. 3 according to the first embodiment with a flowchart (step S300) depicted in FIG. 9. In describing FIG. 9, processes identical to those described in the flowchart of FIG. 3 are denoted by identical step numbers, and the description thereof will be omitted.

Upon receiving instructions to execute encryption via the inquiry screen (“Yes” at step S160), the controller 11 determines whether or not the destination of the multifunctional apparatus 10 is a destination that indispensably requires the encryption target data to be encrypted (step S300).

When determining that the destination of the multifunctional apparatus 10 is a destination indispensably requiring the encryption target data to be encrypted (“Yes” at step S300), the controller judges that the encryption target data has already been encrypted by the encryptor 21. Then, the controller 11 decides to display a confirmation screen with a content notifying that the encryption target data is already encrypted, and thus displays the confirmation screen (step S210).

On the other hand, when determining that the destination of the multifunctional apparatus 10 is a destination other than a destination indispensably requiring the encryption target data to be encrypted (“No” at step S300), the controller 11 judges that the encryption target data has not yet been encrypted by the encryptor 21. Then, the controller 11 decides to display a setting screen that receives an encryption setting for the encryption target data, and thus displays the setting screen (step S180).

The setting screen or confirmation screen displayed by the controller 11 in the second embodiment may have a display configuration analogous to the setting screen W40 (FIG. 7) or confirmation screen W50 (FIG. 8) described in the first embodiment, and thus the description thereof will be omitted.

As described above, according to the second embodiment, in addition to the effects of the first embodiment, the encryption of the encryption target data is forcibly executed depending on the destination of the image processing apparatus, so that it is possible for the user to complete the security setting (initial setting wizard) including the encryption setting without being conscious of encryption status of the encryption target data by the encryptor.

### 3. Third Embodiment

The third embodiment has a configuration in which it is determined, based on presence or absence of an encryption setting for encryption target data at the time of shipment and a security condition of an image processing apparatus, whether to display one of a setting screen that receives an encryption setting for encryption target data or a confirmation screen with a content notifying that encryption target data has already been encrypted. In the third embodiment, two security conditions will be described, as the security condition of the image processing apparatus, i.e., a security condition complying with a security policy provided by a profile such as HCDcPP, installation of an apparatus option, firmware update, etc., and a standard security condition having a security level lower than that of the security condition complying with the security policy and standardly installed in the image processing apparatus.

The functional configuration of a multifunctional apparatus as the image processing apparatus according to the third embodiment may be analogous to the functional configuration of the multifunctional apparatus 10 according to the first embodiment, and thus the description thereof will be omitted.

### 3.1. Processing Flow

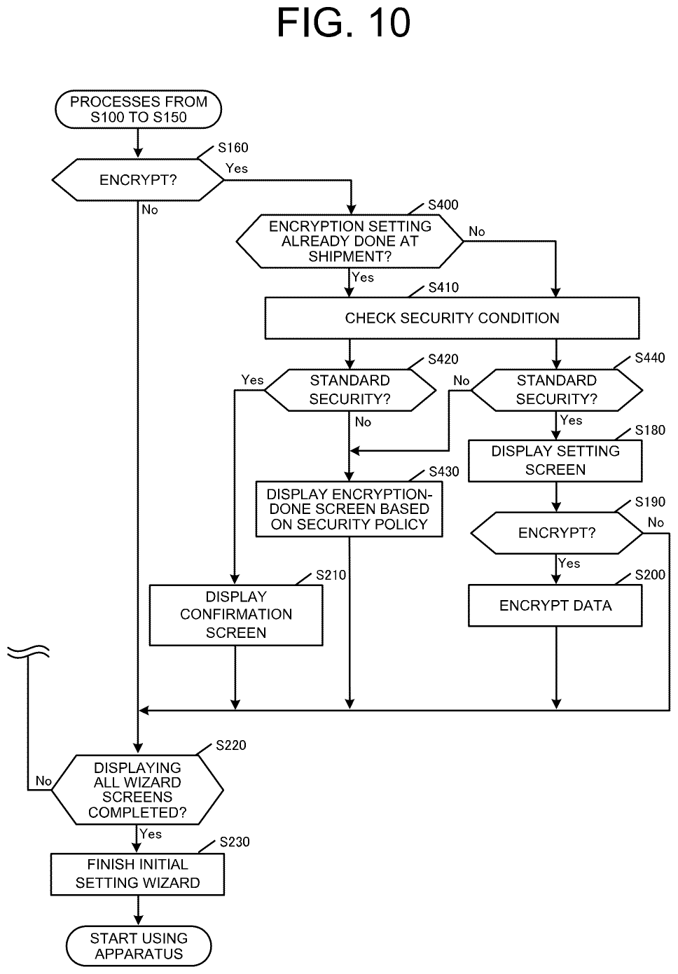

A processing flow according to the third embodiment is configured by replacing the flowchart depicted in FIG. 3 according to the first embodiment with a flowchart depicted in FIG. 10. To facilitate the description, the processes included in steps S160 to S220 in FIG. 10 will be described in an extractive manner. In describing FIG. 10, processes identical to those described in the flowchart of FIG. 3 are denoted by identical step numbers, and the description thereof will be omitted.

Upon receiving instructions to execute encryption for the encryption target data via the inquiry screen (“Yes” at step S160), the controller 11 checks the presence or absence of an encryption setting at the time of shipment (step S400). When determining that the encryption setting at the time of shipment is present and effective (“Yes” at step S400), the controller 11 checks the security condition of the multifunctional apparatus 10 (step S410).

Then, the controller 11 determines whether or not the checked security condition of the multifunctional apparatus 10 is a standard security condition (step S420). When determining that the checked security condition of the multifunctional apparatus 10 is the standard security condition (“Yes” at step S420), the controller 11 displays a confirmation screen (step S210). On the other hand, when determining that the checked security condition of the multifunctional apparatus 10 is not the standard security condition but a security condition complying with a security policy (“No” at step S420), the controller 11 displays an encryption-done screen based on the security policy (step S430).

When determining that the encryption setting at the time of shipment is absent and ineffective (“No” at step S400), the controller 11 checks the security condition of the multifunctional apparatus 10 (step S410).

Then, the controller 11 determines whether or not the checked security condition of the multifunctional apparatus 10 is a standard security condition (step S440). When determining that the checked security condition of the multifunctional apparatus 10 is the standard security condition (“Yes” at step S440), the controller 11 decides to display a setting screen that receives an encryption setting, and thus displays the setting screen (step S180). Then, the controller 11 executes the processes at step S180 and subsequent steps.

On the other hand, when determining that the checked security condition of the multifunctional apparatus 10 is not the standard security condition but a security condition complying with a security policy (“No” at step S440), the controller 11 displays an encryption-done screen based on the security policy (step S430).

### 3.2. Operation Example

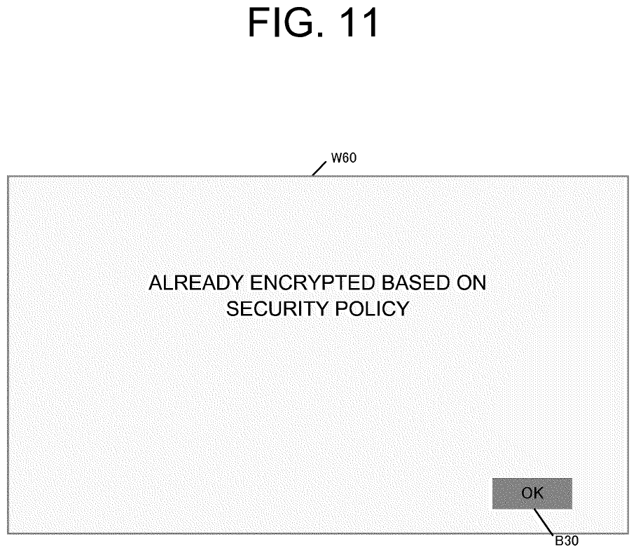

FIG. 11 is an illustration explaining an example of configuration of an encryption-done screen W60 based on a security policy displayed by the controller 11 in a case where the security condition of the multifunctional apparatus 10 is a security condition complying with the security policy. FIG. 11 depicts an operation example corresponding to the process at step S430 in FIG. 10.

The encryption-done screen W60 is a confirmation screen that notifies that the security condition of the multifunctional apparatus 10 complies with the security policy and thus the encryption target data has already been encrypted, and enables for the user to confirm the content of the notification. The encryption-done screen W60 includes a notification that the encryption target data has already been encrypted by complying with the security policy (e.g., “Already encrypted based on security policy”) and an OK button B30. The user who has confirmed that the encryption target data has already been encrypted by complying with the security policy selects the OK button B30. Upon receiving instructions by the selection of OK button B30, the controller 11 finishes the process regarding the encryption setting.

As described above, according to the third embodiment, in addition to the effects of the first embodiment, it is determined, based on the presence or absence of the encryption setting at the time of shipment and the security condition of the image processing apparatus, whether to display one of the setting screen that receives the encryption setting for the encryption target data or the confirmation screen with a content notifying that the encryption target data has already been encrypted, so that it is possible for the user to complete the security setting (initial setting wizard) including the encryption setting without being conscious of encryption status of the encryption target data.

### 4. Fourth Embodiment

The fourth embodiment has a configuration in which, in a case where an encryption setting as setting information set in advance is initialized at the time of repairing an image processing apparatus, a setting screen that receives an encryption setting is displayed. On the other hand, for example, in a case where the content of repairing the image processing apparatus relates to a part other than a storage associated with an encryption setting and thus the encryption setting set in advance is not initialized, displaying a setting screen that receives an encryption setting is omitted, so as to avoid an unnecessary operation for a user.

The functional configuration of the multifunctional apparatus as the image processing apparatus according to the fourth embodiment may be analogous to the functional configuration of the multifunctional apparatus 10 according to the first embodiment, and thus the description thereof will be omitted.

### 4.1. Processing Flow

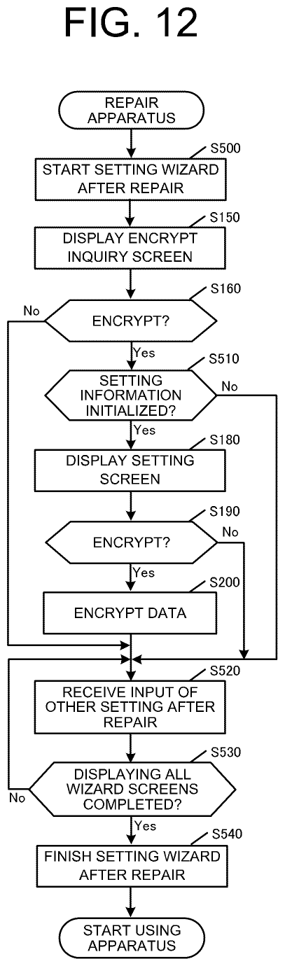

A processing flow according to the fourth embodiment is configured by replacing the flowchart depicted in FIG. 3 according to the first embodiment with a flowchart depicted in FIG. 12. In describing FIG. 12, processes identical to those described in the flowchart of FIG. 3 are denoted by identical step numbers, and the description thereof will be omitted.

After completion of repairing the multifunctional apparatus 10, the controller 11 starts a setting wizard (step S500). Upon starting the setting wizard, the controller 11 displays an inquiry screen that inquires whether to encrypt the encryption target data in the multifunctional apparatus 10 (step S150).

Upon receiving instructions to execute encryption via the inquiry screen (“Yes” at step S160), the controller 11 determines whether or not the encryption setting set in advance is already initialized (step S510). If determining that the encryption setting is already initialized (“Yes” at step S510), the controller 11 decides to display a setting screen that receives the encryption setting, and thus displays the setting screen (step S180).

Note that in a case where the content of repairing the multifunctional apparatus 10 involves initialization of the encryption setting, the setting screen that receives the encryption setting is displayed even if the repaired multifunctional apparatus 10 will be used in the same company or shipped to another company.

After displaying the setting screen, the controller 11 executes the processes from step S180 to step S200.

After encrypting the data at step S200, the controller 11 receives an input of setting other than the encryption setting (step S520). Next, the controller 11 determines whether or not displaying all wizard screens has been completed (step S530). If determining that displaying all wizard screens has been completed (“Yes” at step S530), the controller 11 finishes the setting wizard after repair and starts using the apparatus (step S540). If determining that displaying all wizard screens has not been completed (“No” at step S530), the controller 11 returns the process to step S520.

If determining that, at step S160, the instructions to execute encryption has not been received via the inquiry screen (“No” at step S160), the controller 11 proceeds with the process to step S520.

Also, if determining that, at step S510, the encryption setting has not been initialized (“No” at step S510), the controller 11 decides to omit displaying the setting screen that receives the encryption setting, thus does not display the setting screen, and proceeds with the process to step S520. Thus, in a case where the content of repairing the multifunctional apparatus 10 does not involve the initialization of the encryption setting, displaying the setting screen that receives the encryption setting can be omitted when, for example, the repaired multifunctional apparatus 10 will be used in the same company. In this case, as exemplified in the first to third embodiments, a confirmation screen indicating that the content of repairing does not involve the initialization of the encryption setting may be displayed. On the other hand, even in a case where the content of repairing the multifunctional apparatus 10 does not involve the initialization of the encryption setting, it is preferable that the setting screen that receives the encryption setting is surely displayed when the repaired multifunctional apparatus 10 will be shipped to another company.

As described above, according to the fourth embodiment, in the case where the encryption setting as setting information set in advance has been initialized at the time of repairing the image processing apparatus, the setting screen that receives the encryption setting is displayed, and on the other hand, in the case where, for example, the content of repairing the image processing apparatus relates to a part other than the storage associated with the encryption setting and thus the encryption setting set in advance has not been initialized, displaying the setting screen that receives the encryption setting is omitted, so that it is possible to avoid the unnecessary operation for the user.

The present disclosure is not limited to the aforementioned embodiments, and various modifications can be made. In other words, embodiments obtained by combining technical means suitably modified within a scope not departing from the gist of the present disclosure are also included in the technical scope of the present disclosure.

Although the aforementioned embodiments are described separately for convenience of explanation, obviously the embodiments may be performed in combination within technical capabilities.

The program that operates in each device in the embodiments is a program that controls a CPU, etc. (a program that makes a computer function), so as to actualize the functions of the aforementioned embodiments. Information handled by the devices is temporarily stored in a temporary storage device (e.g., a RAM) at the time of processing, then stored in a storage device such as various ROMs or HDDs, and is read, modified, or written by the CPU as needed.

In this connection, a non-transitory computer-readable storage medium in which programs in information processing equipment are recorded may be any of a semiconductor medium (e.g., a ROM, a nonvolatile memory card, etc.), an optical recording medium/magneto-optical recording medium (e.g., a digital versatile disc (DVD), a magneto optical disc (MO), a mini disc (MD), a compact disc (CD), a Blu-ray (registered trademark) disc (BD), etc.), a magnetic recording medium (e.g., a magnetic tape, a flexible disk, etc.), and so forth. In this case, the program recorded in the recording medium is read by a computer of the information processing equipment and executed by the computer, whereby not only the functions of the aforementioned embodiments are actualized, but also the functions of the present disclosure are actualized by processing in cooperation with an operating system, another application program, etc., on the basis of instructions of the program.

In a case of distribution in the market, the program can be stored in a portable recording medium and distributed, or can be transferred to a server computer connected via a network such as the Internet. In this case, obviously a storage device of the server computer is also included in the present disclosure.

Each functional block or various features of devices used in the aforementioned embodiments can be implemented in or executed by an electric circuit such as an integrated circuit or a plurality of integrated circuits. The electric circuit designed to actualize the functions described in the present disclosure may include a general purpose processor, a digital signal processor (DSP), an application specific integrated circuit (ASIC), a field programmable gate array (FPGA), other programmable logic device, discrete gate or transistor logic, discrete hardware components, or any combination thereof. The general-purpose processor may be a microprocessor, or alternatively a conventional processor, controller, microcontroller or state machine. The above-described electric circuit may be constituted by a digital circuit or alternatively an analog circuit. If an integrated circuit (IC) technology capable of replacing the current integrated circuit appears due to the progress of semiconductor technology, one or more aspects of the present disclosure can use a new integrated circuit according to the IC technology.

While there have been described what are at present considered to be certain embodiments of the disclosure, it will be understood that various modifications may be made thereto, and it is intended that the appended claim cover all such modifications as fall within the true spirit and scope of the disclosure.

What is claimed is:

1. An image processing apparatus comprising:
an encryptor that encrypts data;
one or more controllers that control receiving of encryption setting for the data; and
a display,
wherein the one or more controllers display, on the display, one of a setting screen that receives the encryption setting or a confirmation screen with a content notifying that the data is already encrypted, in accordance with an encryption status of the data by the encryptor.

2. The image processing apparatus of claim 1, wherein
the one or more controllers display the one of the setting screen or the confirmation screen based on a factory default setting of the image processing apparatus.

3. The image processing apparatus of claim 2, wherein
the factory default setting is set in accordance with a destination of the image processing apparatus.

4. The image processing apparatus of claim 2, wherein
the one or more controllers further display the one of the setting screen or the confirmation screen based on a security condition of the image processing apparatus.

5. The image processing apparatus of claim 1, wherein
the one or more controllers omit displaying the setting screen on the display while displaying the confirmation screen on the display, if the encryption status of the data indicates that the data is already encrypted.

6. An image processing apparatus comprising:
an encryptor that encrypts data based on setting information set in advance;
one or more controllers that control receiving of encryption setting for the data; and
a display,
wherein the one or more controllers control one of displaying, on the display, of a setting screen that receives the encryption setting or omitting of the displaying of the setting screen on the display, in accordance with an initialization status of the setting information of the image processing apparatus.

7. The image processing apparatus of claim 6, wherein
the one or more controllers display the setting screen according to a setting wizard after initialization, if the setting information is already initialized.

8. An encryption setting method in an image processing apparatus including an encryptor that encrypts data; one or more controllers that control receiving of encryption setting for the data; and a display, the method comprising:
displaying, on the display, one of a setting screen that receives the encryption setting or a confirmation screen with a content notifying that the data is already encrypted, in accordance with an encryption status of the data by the encryptor.
